(19) United States
(12) Patent Application Publication
(10) Pub. No.: US 2009/0115388 A1
(43) Pub. Date: May 7, 2009

(54) DC/DC converter

(75) Inventors: Masato Miyazaki, Hamamatsu-shi (JP); Toshio Maejima, Iwata-shi (JP)

Correspondence Address: PILLSBURY WINTHROP SHAW PITTMAN LLP, P.O BOX 10500, McLean, VA, 22102, US

(73) Assignee: Yamaha Corporation, Hamamatsu-shi (JP)

(21) Appl. No.: 12/288,094

(22) Filed: Oct. 16, 2008

(30) Foreign Application Priority Data
Oct. 18, 2007 (JP) 2007-271844

(51) Int. Cl. G05F 1/00

(52) U.S. Cl. 323/282

(57) ABSTRACT

A DC/DC converter is constituted of a switching element (e.g., a MOS transistor), an LC low-pass filter constituted of an inductor and a capacitor, and a control circuit for controlling the on/off timing of the switching element such that the output voltage is set to a predetermined voltage value. A series circuit (serving as a snubber circuit) constituted of a resistor and a switch is further connected in parallel with the inductor. The control circuit closes the switch so that the resistor is connected in parallel with the inductor in a resonance mode of the LC low-pass filter. Thus, it is possible to dissipate energy accumulated in the inductor in a short time without using a relatively large circuit scale, thus avoiding the occurrence of ringing.

### BACKGROUND OF THE INVENTION

1. Field of the Invention

The present invention relates to DC/DC converters and in particular to chopper-type DC/DC converters.

The present application claims priority on Japanese Patent Application No. 2007-271844, the content of which is incorporated herein by reference.

2. Description of the Related Art

In DC/DC converters having resonance circuits, ringing occurs due to transition from on states to off states of switching elements connected to resonance circuits. In order to suppress ringing, a DC/DC converter (see Patent Document 1) is equipped with a snubber circuit constituted of a resistor and a capacitor in a resonance circuit.
Patent Document 1: Japanese Unexamined Patent Application Publication No. H07-111779

Patent Document 1 teaches a DC/DC converter constituted of a switching-control power circuit using a transformer. The above constitution is applied to chopper-type DC/DC converters not using transformers.

FIG. 5 shows the overall constitution of a chopper-dropping-type DC/DC converter not using a transformer. The source of a p-channel MOS (or PMOS) transistor Q10 is connected to a terminal 101 supplied with a positive supply voltage PV_{DD}, and the drain of the PMOS transistor Q10 is connected to the drain of an n-channel MOS (or NMOS) transistor Q11.

The source of the NMOS transistor Q11 is grounded. Both the drain of the PMOS transistor Q10 and the drain of the NMOS transistor Q11 are connected to a terminal SW_{OUT}. An inductor L1 is connected between the terminal SW_{OUT} and a terminal OUT. A capacitor (or a condenser) C₁ is connected to the terminal OUT and is grounded. A load resistor R_{L} is connected to the terminal OUT and is grounded.

A snubber circuit 100, which is a series circuit constituted of a resistor R₀ and a capacitor C₀, is connected to the terminal SW_{OUT} and is grounded.

The PMOS transistor Q10, the NMOS transistor Q11, and the terminal SW_{OUT} (as well as a control circuit, not shown) are collectively formed in an IC chip of the DC/DC converter, while the other circuitry (including the snubber circuit 100 and an LC low-pass filter constituted of the inductor L₁ and the capacitor C₁) connected to the terminal SW_{OUT} is arranged externally of the IC chip.

In the above constitution, the control circuit (not shown) outputs gate signals PG and NG so as to perform switching control on the PMOS transistor Q10 and the NMOS transistor Q11, whereby a DC voltage output from the terminal OUT is controlled to have a desired voltage value. When both the PMOS transistor Q10 and the NMOS transistor Q11 are simultaneously turned off, the LC low-pass filter serves as an equivalent circuit shown in FIG. 6 without consideration of the snubber circuit 100, wherein a parasitic capacitance C_{S} is connected to the inductor L₁ and the capacitor C₁. This constitution maintains a resonance state so as to cause ringing in which the voltage at the terminal SW_{OUT} may exceed the supply voltage.

The snubber circuit 100 is used to absorb and suppress ringing, wherein ringing can be suppressed by reducing the resistance of the resistor R₀. However, this increases a power loss due to the snubber circuit 100 connected to the DC/DC converter.

When the resistance of the resistor R₀ is increased, the time constant is correspondingly increased, wherein it is very difficult to suppress ringing in a short time.

Since the snubber circuit 100 is an external component of the IC chip of the DC/DC converter, it enlarges the circuit scale so as to push up the manufacturing cost.

### SUMMARY OF THE INVENTION

It is an object of the present invention to provide a DC/DC converter which is capable of dissipating energy accumulated in an inductor of a resonance circuit due to switching in a short time without using a relatively large circuit scale.

In one embodiment of the present invention, a DC/DC converter is constituted of a switching element (e.g., a MOS transistor), an LC low-pass filter constituted of an inductor, which is connected to the switching element, and a capacitor, a series circuit constituted of a resistor and a switch which are connected in series and in parallel with the inductor included in the LC low-pass filter, and a control circuit for controlling the on/off timing of the switching element such that the output voltage of the LC low-pass filter is set to a predetermined voltage value, wherein the control circuit closes the switch of the series circuit so that the resistor is connected in parallel with the inductor in a resonance mode of the LC low-pass filter.

In the transition from the ON state to the OFF state in the switching element, the LC low-pass filter functions as a resonance circuit, wherein the control circuit closes the switch included in the series circuit so that the resistor is connected in parallel with the inductor, so that energy accumulated in the inductor is consumed by the resistor, thus avoiding the occurrence of ringing. By reducing the resistance of the resistor, it is possible to suppress ringing in a short time. Since the resistor included in the series circuit (serving as a snubber circuit) is connected in parallel with the inductor only in the resonance mode, it is possible to reduce power loss in the DC/DC converter compared to the foregoing circuitry even when the resistance is reduced, thus improving the power conversion efficiency.

Since the snubber circuit is formed inside an IC chip of the DC/DC converter, it is possible to reduce the circuit scale in comparison with the foregoing circuitry, thus reducing the manufacturing cost.

The switching element is constituted of a first switching element supplied with a first DC voltage (i.e., a DC supply voltage PV_{DD}) and a second switching element supplied with a second DC voltage (i.e., a ground potential) which is lower than the first DC voltage, wherein the LC low-pass filter is connected to the connection point between the first switching element and the second switching element which are connected in series. The control circuit closes the switch of the series circuit when both the first switching element and the second switching element are simultaneously turned off.

When both the first and second switching elements are simultaneously turned off, the LC low-pass filter functions as the resonance circuit, wherein the control circuit turns on the switch of the series circuit (including the resistor) which is connected in parallel with the inductor of the LC low-pass filter. Since energy accumulated in the inductor of the LC low-pass filter is consumed by the resistor of the series circuit, it is possible to avoid the occurrence of ringing, wherein ringing can be suppressed in a short time by reducing the resistance.

In another embodiment of the present invention, a DC/DC converter is constituted of an inductor supplied with a first DC voltage (e.g., a DC supply voltage PV_{DD}), a switching element (e.g., a MOS transistor) supplied with a second DC voltage (e.g., a ground potential) which is lower than the first DC voltage, a diode whose anode is connected to the connection point between the inductor and the switching element which are connected in series, a capacitor connected to the cathode of the diode in connection with the second DC voltage, a series circuit constituted of a resistor and a switch which are connected in series and in parallel with the inductor, and a control circuit for controlling the on/off timing of the switching element such that the output voltage derived from the capacitor is set to a predetermined voltage value, wherein the control circuit closes the switch of the series circuit so that the resistor is connected in parallel with the inductor in the resonance mode.

The control circuit closes the switch so that the resistor is connected in parallel with the inductor in the resonance mode, wherein energy accumulated in the inductor is consumed by the resistor, thus avoiding the occurrence of ringing. Ringing can be suppressed in a short time by reducing the resistance.

In this connection, each of the above DC/DC converters further includes an error amplifier for detecting an error voltage between the output voltage and the reference voltage. The control circuit controls the switching element and the switch in response to the error voltage such that the output voltage is approximately set to the reference voltage.

### BRIEF DESCRIPTION OF THE DRAWINGS

These and other objects, aspects, and embodiments of the present invention will be described in more detail with reference to the following drawings.

FIG. 1 is a circuit diagram showing the constitution of a DC/DC converter in accordance with a first embodiment of the present invention.

FIG. 2A shows a waveform representing an output voltage V_{OUT} of the DC/DC converter shown in FIG. 1.

FIG. 2B shows a waveform representing a level at a terminal SW_{OUT} in the DC/DC converter shown in FIG. 1.

FIG. 2C shows a waveform representing a gate signal PG applied to a transistor Q1 in the DC/DC converter shown in FIG. 1.

FIG. 2D shows a waveform representing a gate signal NG applied to a transistor Q2 in the DC/DC converter shown in FIG. 1.

FIG. 2E shows a waveform representing a control signal SW for controlling a switch SW₁ in the DC/DC converter shown in FIG. 1.

FIG. 2F shows a waveform representing a current I_{L} flowing through an inductor L₁ in the DC/DC converter shown in FIG. 1.

FIG. 3 is a circuit diagram showing the constitution of a DC/DC converter in accordance with a second embodiment of the present invention.

FIG. 4A shows a waveform representing a current I_{L} flowing through an inductor L₁₀ in the DC/DC converter shown in FIG. 3.

FIG. 4B shows a waveform representing a gate signal NG applied to a transistor Q3 in the DC/DC converter shown in FIG. 3.

FIG. 4C shows a waveform representing a level at a terminal SW_{OUT} in connection with an output voltage V_{OUT} in the DC/DC converter shown in FIG. 3.

FIG. 5 is a circuit diagram showing a typical example of a chopper-dropping-type DC/DC converter.

FIG. 6 is a circuit diagram showing an equivalent circuit used for explaining a resonating state of a resonance circuit included in the DC/DC converter shown in FIG. 5.

### DESCRIPTION OF THE PREFERRED EMBODIMENTS

The present invention will be described in further detail by way of examples with reference to the accompanying drawings.

### 1. First Embodiment

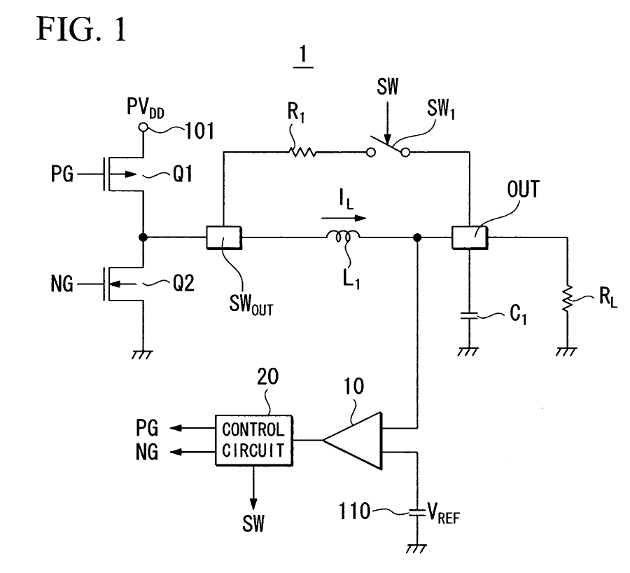

FIG. 1 shows the constitution of a DC/DC converter 1 in accordance with a first embodiment of the present invention. A terminal 101 is supplied with a positive DC supply voltage PV_{DD} and is connected to the source of a p-channel MOS (or PMOS) transistor Q1, the drain of which is connected to the drain of an n-channel MOS (or NMOS) transistor Q2.

The source of the NMOS transistor Q2 is grounded. Both the drain of the PMOS transistor Q1 and the drain of the NMOS transistor Q2 are connected to a terminal SW_{OUT}. An inductor L₁ is connected between the terminal SW_{OUT} and a terminal OUT. A capacitor C₁ is connected to the terminal OUT and is grounded. A load resistor R_{L} is connected to the terminal OUT and is grounded. The inductor L₁ and the capacitor C₁ form an LC low-pass filter.

A snubber circuit, which is a series circuit constituted of a resistor R₁ and a switch SW₁, is connected between both ends of the inductor L₁, i.e., between the terminals SW_{OUT} and OUT.

The DC/DC converter 1 of the first embodiment further includes an error amplifier 10 and a control circuit 20. The first input terminal of the error amplifier 10 is connected to the terminal OUT, and the second input terminal thereof is connected to a reference voltage source 110 for generating a reference voltage (or a target voltage) V_{REF}. The control circuit 20 receives an output signal of the error amplifier 10 so as to generate gate signals PG and NG, by which switching control is performed on the PMOS transistor Q1 and the NMOS transistor Q2 such that a predetermined output voltage (substantially corresponding to the reference voltage V_{REF}) emerges at the terminal OUT.

When resonance occurs at the terminal SW_{OUT}, in other words, at the timing when ringing occurs, the control circuit 20 generates a control signal SW for closing the switch SW₁.

All of the PMOS transistor Q₁, the NMOS transistor Q₂, the terminal SW_{OUT}, the resistor R₁, the switch SW₁, the terminal OUT, the error amplifier 10, the reference voltage source 110, and the control circuit 20 are formed in an IC chip of the DC/DC converter 1, while the inductor L₁, the capacitor C₁, and the load resistor R_{L} are external components externally connected to the IC chip.

The first embodiment is designed such that the snubber circuit (i.e., a series circuit constituted of the resistor R₁ and the switch SW₁) is formed in the IC chip.

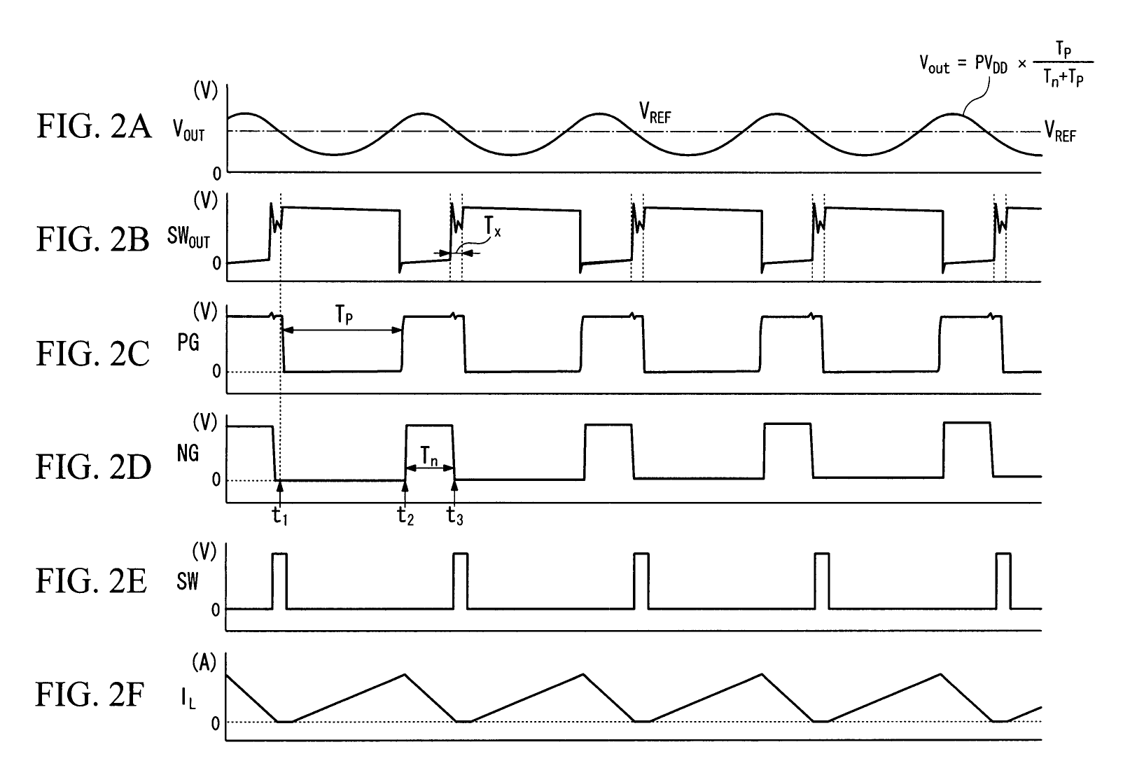

Next, the operation of the DC/DC converter 1 of the first embodiment will be described with reference to waveforms shown in FIGS. 2A to 2F. Specifically, the control circuit 20 performs switching control on the PMOS transistor Q1 and the NMOS transistor Q2 by way of the gate signals PG and NG such that an output voltage V_{OUT} at the terminal OUT substantially matches the reference voltage V_{REF}.

At time t1 when both of the gate signals PG and NG output from the control circuit 20 are set to a low level (see FIGS. 2C and 2D), the PMOS transistor Q1 is turned on while the NMOS transistor Q2 is turned off so as to allow a current I_{L} to flow through the inductor L₁ via the PMOS transistor Q1 from the terminal 101 supplied with the positive DC supply voltage PV_{DD}. The value of the current I_{L} (see FIG. 2F) increases over a lapse of time so that energy is accumulated in the inductor L₁. In this period, the output voltage V_{OUT} of the DC/DC converter 1 continuously decreases because charges accumulated in the capacitor C₁ are discharged via the load resistor R_{L}.

At time t2 when the current I_{L} reaches a predetermined value, both of the gate signals PG and NG output from the control circuit 20 are set to a high level, whereby the PMOS transistor Q1 is turned off while the NMOS transistor Q2 is turned on. At this time, the current I_{L} continuously flows through the inductor L₁ via the NMOS transistor Q2 (from the ground) while decreasing, thus charging the capacitor C₁. Thus, the output voltage V_{OUT} at the output terminal OUT of the DC/DC converter 1 starts to increase (see FIG. 2A).

Since variations of the current I_{L} flowing through the inductor L₁ in an ON-period T_{P} of the PMOS transistor Q1 is identical to variations of the current I_{L} flowing through the inductor L₁ in an ON-period TN of the NMOS transistor Q2, the output voltage V_{OUT} (see FIG. 2A) can be expressed by an equation (1).

$${V}_{OUT} = {PV}_{DD} \cdot \frac{{T}_{P}}{{T}_{N} + {T}_{P}} \qquad ( 1 )$$

In FIG. 2B, T_{X} represents an OFF-period in which both the PMOS transistor Q1 and the NMOS transistor Q2 are turned off.

The error amplifier 10 compares the output voltage V_{OUT} (output from the terminal OUT of the DC/DC converter 1) to the reference voltage (or target voltage) V_{REF} so as to output an error voltage. The control circuit 20 adequately controls the PMOS transistor Q1 and the NMOS transistor Q2 to be turned on or off in such a way that the error voltage output from the error amplifier 10 decreases to zero, whereby the control circuit 20 controls the output voltage V_{OUT} to substantially match a desired voltage value.

At time t3 when the current I_{L} flowing through the inductor L₁ becomes zero, the NMOS transistor Q2 is turned off, whereby both the PMOS transistor Q1 and the NMOS transistor Q2 are simultaneously turned off. At this timing, ringing occurs at the terminal SW_{OUT}, whereas the switch SW1 is turned on in response to the control signal SW output from the control circuit 20 (see FIG. 2E), whereby energy accumulated in the inductor L₁ is consumed by the resistor R₁, thus suppressing ringing (see FIG. 2B).

In the DC/DC converter 1 of the first embodiment, energy accumulated in the inductor L₁ included in the LC low-pass filter is consumed by the resistor R₁ included in the series circuit, thus avoiding the occurrence of ringing.

By reducing the resistance of the resistor R₁, it is possible to suppress ringing in a short time.

In the above, the resistor R₁ included in the series circuit serving as the snubber circuit is connected in parallel with the inductor L₁ via the switch SW₁ only in a resonance mode; hence, it is possible to reduce power loss even when the resistance is reduced in the first embodiment compared to the foregoing circuitry; thus, it is possible to improve the power conversion efficiency.

In addition, the series circuit serving as the snubber circuit is formed inside the IC chip of the DC/DC converter 1, which is thus reduced in circuit scale in comparison with the foregoing circuitry, thus reducing the manufacturing cost.

### 2. Second Embodiment

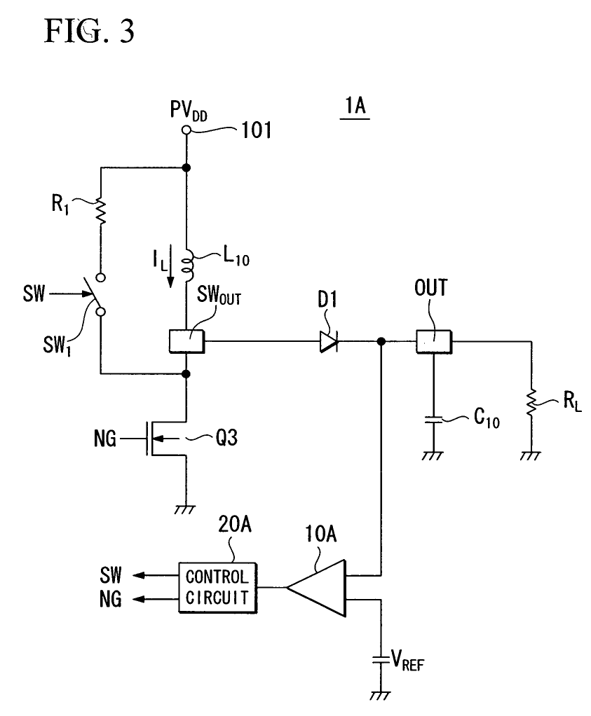

FIG. 3 shows the constitution of a DC/DC converter 1A in accordance with a second embodiment of the present invention, wherein parts identical to those shown in FIG. 1 are designated by the same reference numerals.

An inductor L₁₀ is connected between the terminal 101 (supplied with the positive DC supply voltage PV_{DD}) and the drain of an NMOS transistor Q3. The source of the NMOS transistor Q3 is grounded. The terminal SW_{OUT} is positioned at the connection point between the inductor L₁₀ and the drain of the NMOS transistor Q3 and is connected to the anode of a diode D1 whose cathode is connected to the terminal OUT.

A capacitor C₁₀ (serving as a smoothing capacitor) is connected to the terminal OUT and is grounded. The load resistor R_{L} is connected to the terminal OUT and is grounded.

That is, a snubber circuit corresponding to a series circuit constituted of the resistor R₁ and the switch SW₁ is connected between both ends of the inductor L₁₀.

The DC/DC converter 1A of the second embodiment further includes an error amplifier 10A and a control circuit 20A. The first input terminal of the error amplifier 10A is connected to the terminal OUT, and the second input terminal thereof is connected to the reference voltage source 110 having the reference voltage (or target voltage) V_{REF}. Based on an output signal of the error amplifier 10A, the control circuit 20A outputs the gate signal NG for performing switching control on the NMOS transistor Q3 such that the output voltage output from the terminal OUT substantially matches the reference voltage V_{REF}. At the timing causing ringing, that is, in a resonance mode at the connection point (i.e., the terminal SW_{OUT}) between the inductor L₁₀ and the drain of the NMOS transistor Q3, the control circuit 20A outputs the control signal SW so as to close the switch SW₁.

In the second embodiment, the snubber circuit corresponding to the series circuit constituted of the resistor R₁ and the switch SW₁ is formed inside an IC chip of the DC/DC converter 1A. In the circuitry of FIG. 3, the inductor L₁₀, the capacitor C₁₀, and the load resistor R_{L} are arranged externally of the IC chip.

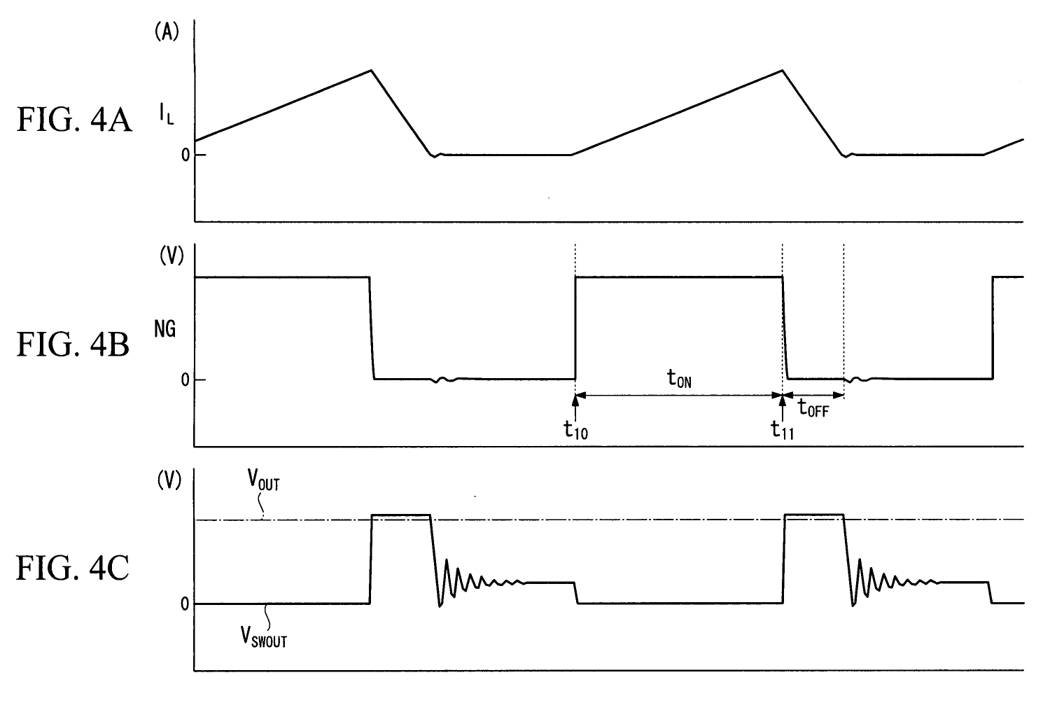

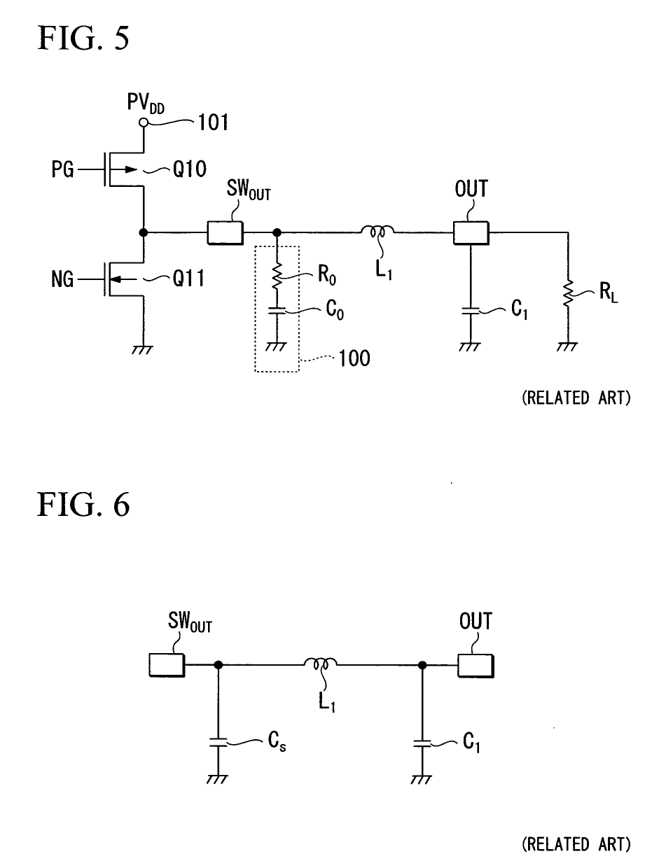

Next, the operation of the DC/DC converter 1A of the second embodiment will be described with reference to FIGS. 4A, 4B, and 4C. Herein, switching control is performed on the NMOS transistor Q3 in response to the gate signal NG output from the control circuit 20A such that the output voltage V_{OUT} (output from the terminal OUT of the DC/DC converter 1A) substantially matches the reference voltage V_{REF} having the predetermined voltage value.

At time t10 when the control circuit 20A changes the gate signal NG from a low level to a high level (see FIG. 4B), the NMOS transistor Q3 is turned on so that the diode D1 is placed in a reverse bias state, i.e., in a non-conduction state. This allows the current I_{L} to flow through the inductor L₁₀ via the NMOS transistor Q3 from the positive DC supply voltage PV_{DD} towards the ground. The value of the current I_{L} increases over a lapse of time, so that energy is accumulated in the inductor L₁₀ (see FIG. 4A).

In the above state, the output voltage VOUT (output from the terminal OUT of the DC/DC converter 1) continuously decreases since charges accumulated in the capacitor C₁₀ are discharged via the load resistor R_{L}.

At time t11 when the control circuit 20A changes the gate signal NG from the high level to the low level, the NMOS transistor Q3 is turned off (see FIG. 4B), so that the diode D1 is placed in a forward bias state, i.e., in a conduction state.

Thus, the current I_{L} flowing through the inductor L₁₀ is forced to continuously flow toward the terminal OUT via the diode D1 while decreasing (see FIG. 4A), thus charging the capacitor C₁₀. This boosts the output voltage V_{OUT} at the output terminal OUT of the DC/DC converter 1A.

In FIG. 4B, t_{ON} designates an ON-period of the NMOS transistor Q3, and t_{OFF} designates an OFF-period of the NMOS transistor Q3 in which an inequality of V_{SWOUT}>(V_{OUT}+V_{DF}) (where V_{DF} designates a forward-direction voltage of the diode D1, and V_{SWOUT} designates the voltage of the terminal SW_{OUT}) is established as well. Since variations of the current I_{L} flowing through the inductor L₁₀ in the ON-period t_{ON} is identical to variations of the current I_{L} flowing through the inductor L₁₀ in the OFF-period t_{OFF}, the output voltage V_{OUT} (see FIG. 4C) is expressed by an equation (2).

$${V}_{OUT} = {PV}_{DD} \cdot \frac{{t}_{ON} + {t}_{OFF}}{{t}_{OFF}} \qquad ( 2 )$$

Through comparison between the output voltage V_{OUT} (output from the terminal OUT of the DC/DC converter 1A) and the reference voltage (i.e., target voltage) V_{REF}, the control circuit 20A appropriately turns on or off the NMOS transistor Q3 based on the error voltage output from the error amplifier 10 such that the error voltage decreases to zero, thus controlling the output voltage V_{OUT} at a desired voltage value.

In a resonance mode at the connection point between the inductor L₁₀ and the drain of the NMOS transistor Q3, ringing occurs at the terminal SWOUT, wherein the control circuit 20A outputs the control signal SW so as to close the switch SW1 so that energy accumulated in the inductor L₁₀ is consumed by the resistor R1, thus suppressing ringing.

In the DC/DC converter 1A of the second embodiment, energy accumulated in the inductor L₁₀ is consumed by the resistor R₁ (which is connected to the switch SW₁ in the series circuit connected in parallel with the inductor L₁₀); hence, it is possible to avoid the occurrence of ringing.

By reducing the resistance of the resistor R₁ included in the series circuit, it is possible to suppress ringing in a short time. Since the resistor R₁ included in the series circuit (serving as the snubber circuit) is connected in parallel to the inductor L₁₀ in a resonance mode, it is possible to reduce power loss in the second embodiment compared to the foregoing circuitry even when the resistance is reduced, thus improving the power conversion efficiency.

Since the snubber circuit is formed inside the IC chip of the DC/DC converter 1A, it is possible to reduce the circuit scale in comparison with the foregoing circuitry, thus reducing the manufacturing cost.

Lastly, the present invention is not necessarily limited to the first and second embodiments, which can be modified in a variety of ways within the scope of the invention defined by the appended claims.

What is claimed is:

1. A DC/DC converter comprising:
a switching element;
an LC low-pass filter constituted of an inductor, which is connected to the switching element, and a capacitor;
a series circuit constituted of a resistor and a switch which are connected in series and in parallel with the inductor included in the LC low-pass filter; and
a control circuit for controlling an on/off timing of the switching element such that an output voltage of the LC low-pass filter is set to a predetermined voltage value,
wherein the control circuit closes the switch of the series circuit so that the resistor is connected in parallel with the inductor in a resonance mode of the LC low-pass filter.

2. A DC/DC converter according to claim 1, wherein the switching element is constituted of a first switching element supplied with a first DC voltage and a second switching element supplied with a second DC voltage which is lower than the first DC voltage,
wherein the LC low-pass filter is connected to a connection point between the first switching element and the second switching element which are connected in series, and
wherein the control circuit closes the switch of the series circuit when both the first switching element and the second switching element are simultaneously turned off.

3. A DC/DC converter according to claim 1, wherein the switching element is constituted using at least one MOS transistor whose on/off timing is controlled by the control circuit.

4. A DC/DC converter according to claim 1 further comprising an error amplifier for detecting an error voltage between the output voltage and a reference voltage, wherein the control circuit controls the switching element and the switch in response to the error voltage such that the output voltage is approximately set to the reference voltage.

5. A DC/DC converter comprising:
an inductor supplied with a first DC voltage;
a switching element supplied with a second DC voltage which is lower than the first DC voltage;
a diode whose anode is connected to a connection point between the inductor and the switching element which are connected in series;
a capacitor connected to a cathode of the diode in connection with the second DC voltage;
a series circuit constituted of a resistor and a switch which are connected in series and in parallel with the inductor; and
a control circuit for controlling an on/off timing of the switching element such that an output voltage derived from the capacitor is set to a predetermined voltage value,
wherein the control circuit closes the switch of the series circuit so that the resistor is connected in parallel with the inductor in a resonance mode of the inductor and the capacitor.

6. A DC/DC converter according to claim 5, wherein the switching element is constituted of a MOS transistor whose on/off timing is controlled by the control circuit.

7. A DC/DC converter according to claim 5 further comprising an error amplifier for detecting an error voltage between the output voltage and a reference voltage, wherein the control circuit controls the switching element and the switch in response to the error voltage such that the output voltage is approximately set to the reference voltage.
